(19) United States
(12) Patent Application Publication
(10) Pub. No.: US 2018/0259172 A1
(43) Pub. Date: Sep. 13, 2018

(54) HEAT DISSIPATION DEVICE FOR LED LAMP

(71) Applicant: Baozhou Xu, Guangdong (CN)

(72) Inventor: Baozhou Xu, Guangdong (CN)

(21) Appl. No.: 15/614,529

(22) Filed: Jun. 5, 2017

(30) Foreign Application Priority Data
Mar. 7, 2017 (CN) 201710131724.3

(51) Int. Cl. F21V 29/75; F21K 9/275; C10M 107/50

(52) U.S. Cl. CPC F21V 29/75; F21V 29/90; C10M 107/50; F21K 9/275

(57) ABSTRACT

Heat dissipation devices for a light emitting diode (LED) lamp are presented including: a base; a number of heat conducting fins vertically stacked and mechanically coupled with the base, where the heat conducting fins radiate outward from the base; and an LED module mechanically coupled with the base. In some embodiments, the base further includes a thermal conductive grease for maximizing heat transfer between the base on the LED socket. In some embodiments, the thermal conductive grease is a silicon grease. In some embodiments, the heat conducting fins further include: a number of vented separators positioned along at least one surface of each of the number of heat conducting fins; a rib feature disposed lengthwise along each surface of each of the number of heat conducting fins.

### FIELD OF INVENTION

The invention relates generally to heat conducting of LED lighting. More specifically, the invention relates to heat conducting of LED vehicle headlights.

### BACKGROUND

The heat dissipation module that the current light emitting diode (LED) vehicle lighting uses are mainly rigid aluminum or copper heat sinks. The space of the headlamp assembly is limited. The size of the rigid heat sinks are often too big to fit into the lamp assembly.

The flexible heat sink that can fit into the confined headlight assembly and can effectively dissipate the heat is the solution. The existing flexible heat sinks for LED headlights uses braided metal band, which is easily to cluster and causing heat accumulation. The flexible heat sinks has other disadvantages, such as higher cost, inconsistent quality, complicated manufacturing process.

What is needed is a new flexible heat dissipation module uses that is more effective in heat dissipation, easier to produce, and lower in cost. As such heat dissipation devices for LED lamps are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, heat dissipation devices for a light emitting diode (LED) lamp are presented including: a base; a number of heat conducting fins vertically stacked and mechanically coupled with the base, where the heat conducting fins radiate outward from the base; and an LED module mechanically coupled with the base. In some embodiments, the base further includes a thermal conductive grease for maximizing heat transfer between the base on the LED socket. In some embodiments, the thermal conductive grease is a silicon grease. In some embodiments, the heat conducting fins further include: a number of vented separators positioned along at least one surface of each of the number of heat conducting fins; a rib feature disposed lengthwise along each surface of each of the number of heat conducting fins. In some embodiments, the vented separators are vertically aligned between the number of heat conducting fins. In some embodiments, the vented separators are non-vertically aligned between the number of heat conducting fins. In some embodiments, the heat conducting fins include a semi-rigid heat conductive metal where the semi-rigid heat conductive metal is aluminum.

In other embodiments, vehicular headlight assemblies are presented including: a headlight housing; a heat dissipation device having an LED lamp where the heat dissipation device is removably coupled with the headlight housing, the heat dissipation device including: a base, a number of heat conducting fins vertically stacked and mechanically coupled with the base, where the number of heat conducting fins radiate outward from the base, and an LED module mechanically coupled with the base, and a wiring loom electrically coupled with the LED module for providing connection with a vehicular headlight loom connection.

In other embodiments, methods for using a heat dissipation device having an LED module are presented including: providing the a heat dissipation device, the heat dissipation device including: a base, a number of heat conducting fins vertically stacked and mechanically coupled with the base, where the heat conducting fins radiate outward from the base, where the LED module is mechanically coupled with the base, and a wiring loom electrically coupled with the LED module for providing connection with a vehicular headlight loom connection; bending the heat conducting fins to fit into a headlight housing; inserting the heat dissipation device into the headlight housing such that the LED module is housed within the headlight housing; securing the heat dissipation device with the headlight housing; and connecting the wiring loom with the vehicular headlight loom connection.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of a heat dissipation device for an LED lamp in accordance with embodiments of the present invention;

FIG. 2 is an illustrative top view representation of a heat dissipation device in accordance with embodiments of the present invention;

FIG. 3 is an illustrative side view representation of a heat dissipation device in accordance with embodiments of the present invention;

FIG. 4 is an illustrative exploded side view representation of a heat conducting fin assembly for a heat dissipation device in accordance with embodiments of the present invention;

FIG. 5 is an illustrative representation of various configurations of heat dissipation devices in accordance with embodiments of the present invention; and

FIG. 6 is an illustrative representation of bending a heat dissipation device in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

The present invention provides a heat dissipation device for an LED lamp for use in vehicular headlights. To conduct the significant amount of heat generated from an LED headlight, a relative larger heat dissipation area of fins may improve heat dissipation efficiency. In embodiments, fins are flexible and can be distorted to fit into the lamp space of a headlight assembly. Embodiments may provide an optimized heat dissipation solution to current solutions. Embodiments include a heat dissipation device that is fixed with a LED vehicle lamp. In particular, embodiments include at least one unit of heat dissipation fins where one end of the unit of heat dissipation fins is attached with a heat dissipation base. Each unit of fins comprises at least two aluminum fins as will be described below for the following figures.

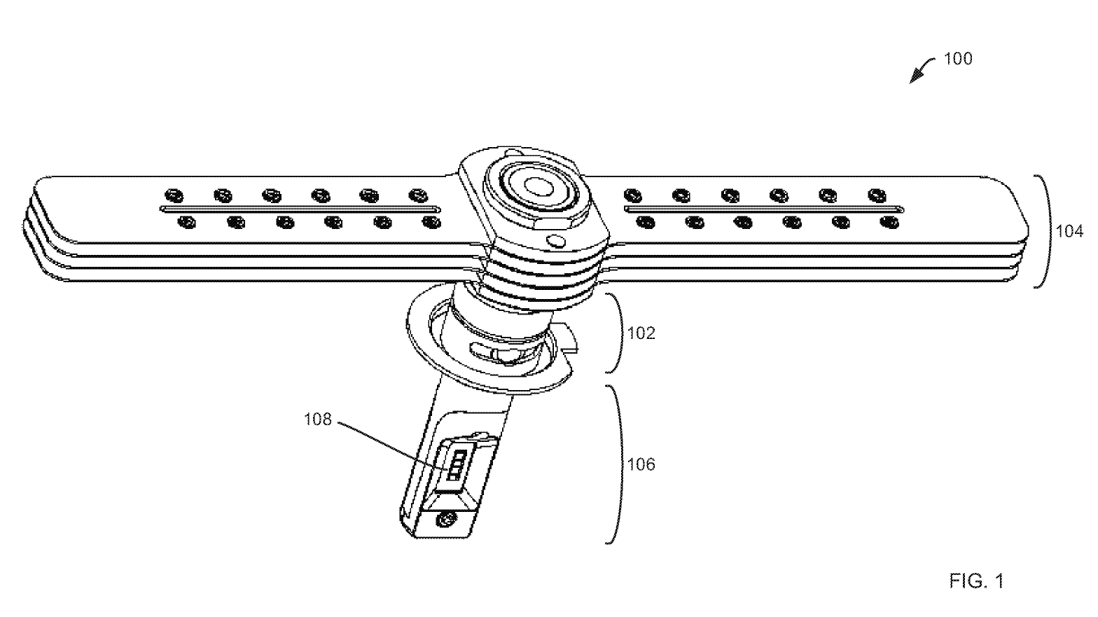

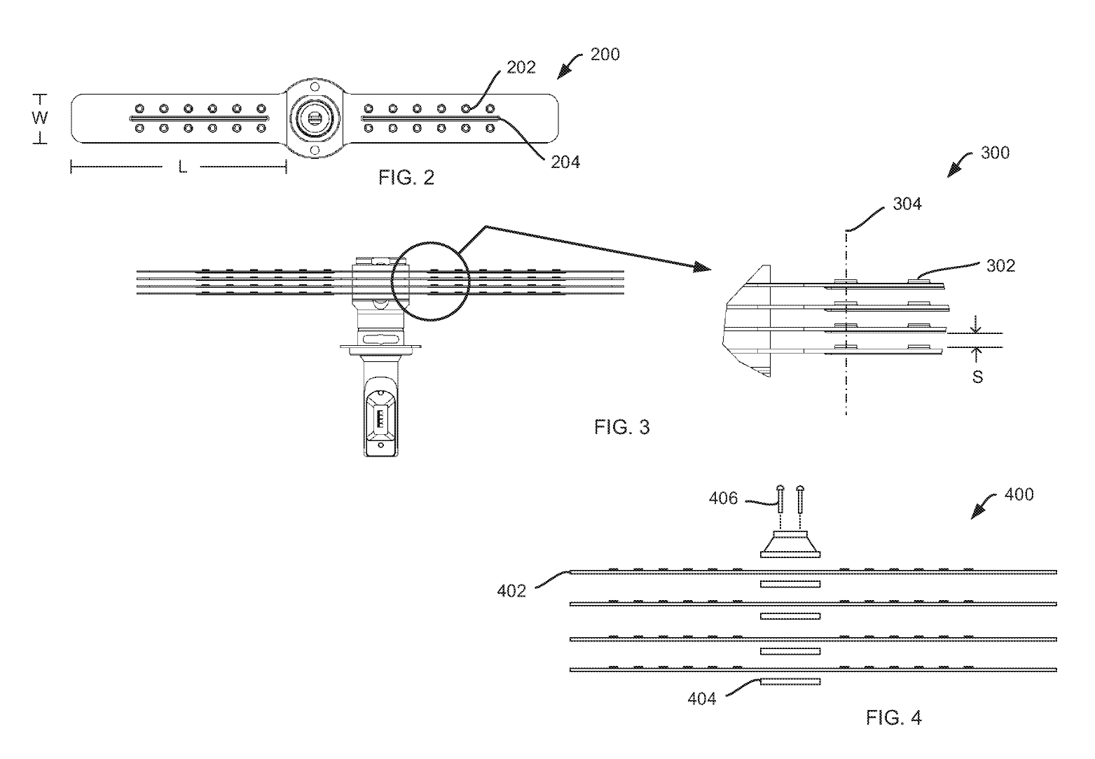

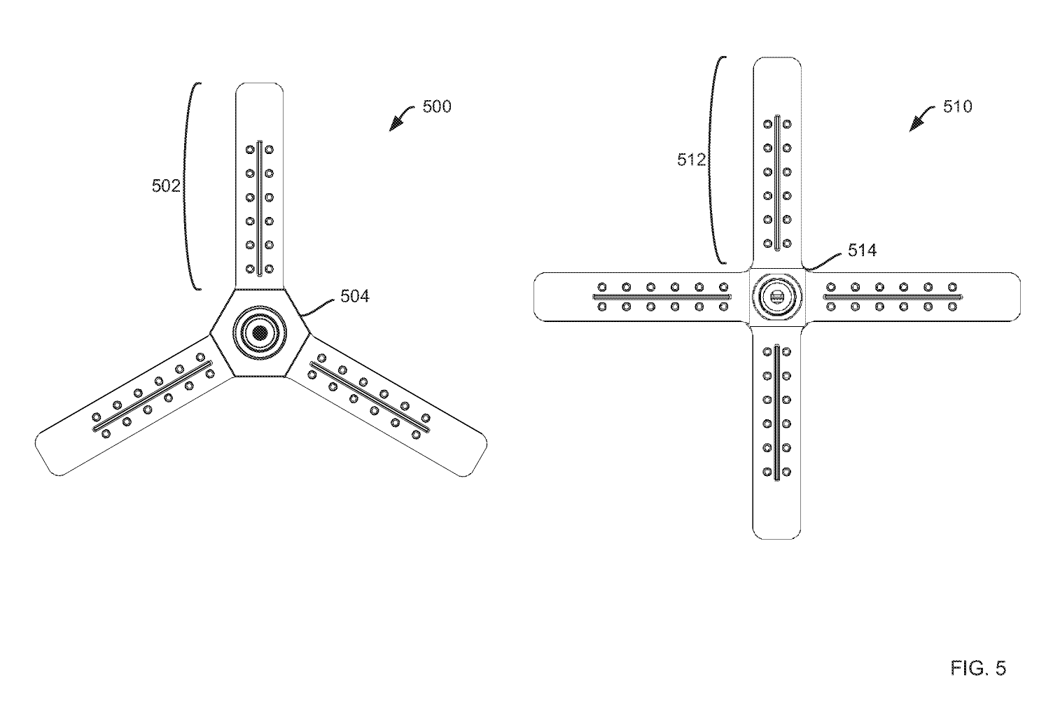

FIG. 1 is an illustrative representation of a heat dissipation device for an LED lamp 100 in accordance with embodiments of the present invention. As illustrated, device 100 includes at least base 102, one or more heat conducting fin assemblies 104 radiating outward from base 102, and LED module 106, which includes LED 108. Base and fin assemblies will be discussed in further detail below for FIGS. 2-4. It may be appreciated that embodiments may be configured in a variety of ways that will be discussed in further detail below for FIG. 5.

FIG. 2 is an illustrative top view representation of a heat dissipation device 200 in accordance with embodiments of the present invention. As illustrated, device 200 includes a number of vented separators 202 disposed along a surface of the heat conducting fin. In embodiments, vented separators serve at least two purposes: 1) vented separators maintain separation between layers of fins and 2) vented separators enhance air flow across and through fins. In current technologies as noted above, flexible heat sinks for LED headlights use braided metal band. While braided metal bands are easily folded to place into a headlight housing, the bands also tend to cluster thus reducing the efficiency of the device. Present embodiment avoid clustering contact between fins by utilizing vented separators. In embodiments, vented separators may maintain separation (S) between the heat conducting fins in a range of approximately 1.0 to 3.0 mm In addition, in embodiments, vented separators may have an outside diameter in a range of approximately 2.0 to 4.0 mm and an inside diameter in a range of approximately 1.0 to 3.0 mm

Turning briefly to FIG. 3, which is an illustrative side view representation of a heat dissipation device in accordance with embodiments of the present invention, the magnified portion 300 of the device illustrates vertically stacked vented separators 302 in vertical alignment between the heat conducting fins as indicated by line 304. Indeed, returning to FIG. 2, vented separators 202 are horizontally aligned in grid fashion across the heated conducting fin surface. However, one skilled in the art will appreciate that vented separators may be non-vertically aligned between the heat conducting fins and may be non-horizontally aligned across the heated conducting fin surface in some embodiments. As such, no limitation should be construed with respect to vertical and horizontal alignment of vented separators in embodiments illustrated. Further illustrated in FIG. 2 is rib feature 204. Rib features may be disposed lengthwise along each surface of the heat conducting fins. Rib feature embodiments may be stamped on heat conducting fins or may be otherwise bonded to a surface of the head conducting fins without limitation. Rib feature embodiments provide a support structure for the heat conducting fins in flat positions as well as in folded positions.

Further illustrated are width line (W) and length line (L). Heat conducting fins may include any configuration of length (L) and width (W) corresponding with a size of headlight housing into which the heat dissipation device is inserted. In some embodiments, heat conducting fin may have a length in a range of approximately 100 to 250 mm and a width of approximately 10 to 25 mm. In other embodiments, heat conducting fin may have a length of approximately 200 mm and a width of approximately 20 mm. In still other embodiments, heat conducting fin may have a thickness in a range of approximately 0.1 to 2.5 mm. As such, a variety of dimensions and configurations may be utilized without limitation and without departing from embodiments provided herein.

FIG. 4 is an illustrative exploded side view representation of a heat conducting fin assembly 400 for a heat dissipation device in accordance with embodiments of the present invention. As illustrated, assembly 400 includes a number of heat conducting fins 402 and spacers 404 that may be mechanically coupled with rivets 406. The spacers may be selected for a desired thickness without limitation and without departing from embodiments provided herein. The heat conducting fin embodiments may be manufactured from a semi-rigid heat conductive metal such as aluminum for example. However, any suitable semi-rigid heat conductive metal may be utilized without limitation and without departing from embodiments provided herein.

FIG. 5 is an illustrative representation of various configurations of heat dissipation devices in accordance with embodiments of the present invention. In other illustrative representations, two heat conducting fin stacks that radiate outward from the base. FIG. 5 presents other configurations that may be suitable for use with a vehicular headlight. In particular, in one embodiment, heat dissipation device 500 represents three heat conducting fin stacks 502 radiating outward from base 504. In another embodiment, heat dissipation device 510 represents four heat conducting fin stacks 512 radiating outward from base 514. Thus it will be seen by one skilled in the art, that any number of fin stacks may be configured using techniques and embodiments disclosed herein. While there is a practical limit to the number of fin stacks that may be utilized, the number, shape, and dimensions of such fin stacks should not be construed as limiting.

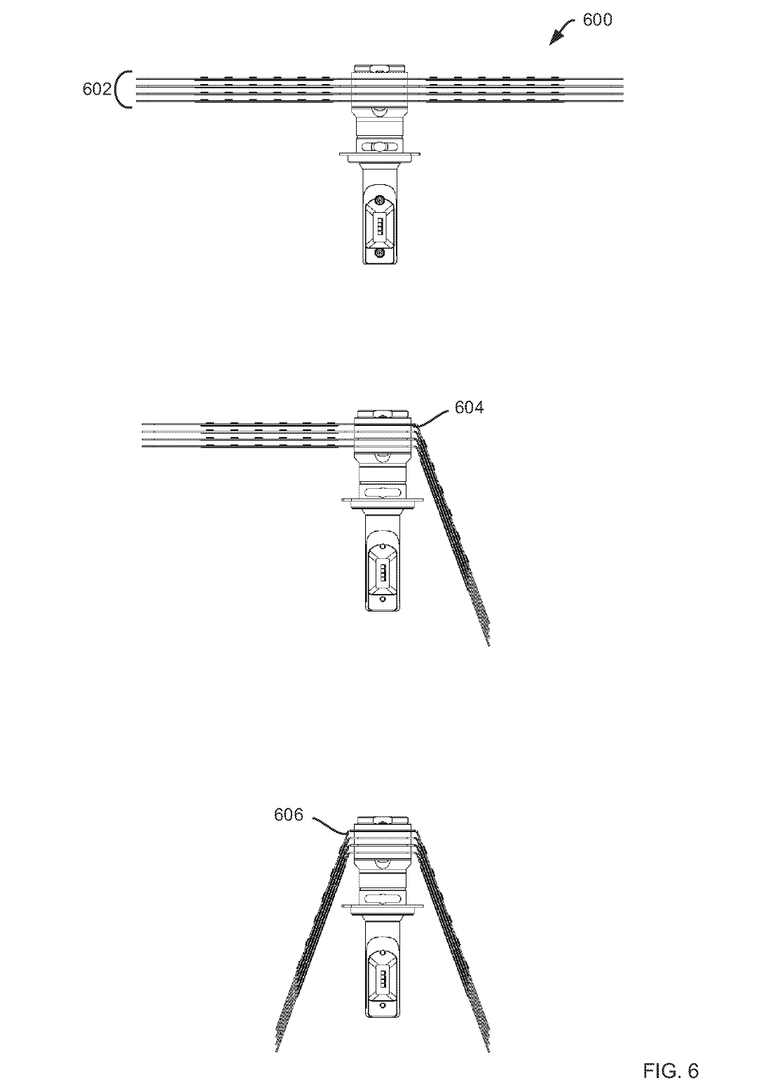

FIG. 6 is an illustrative representation of bending a heat dissipation device 600 in accordance with embodiments of the present invention. As illustrated, heat conducting fins 602 may be bent in one or more places. For example device 600 may be first bent at 604 and again at 606 prior to insertion into a headlight housing that is part of a vehicular headlight assembly. While only two bends are illustrated, it may be appreciated that any number of bends may be made without departing from embodiments provided herein. Importantly, regardless of the number of bends made, the heat conducting fins will maintain a separation so that effective and efficient heat dissipation may be accomplished.

Methods

The following method may be utilized with embodiments provided herein namely:

providing a heat dissipation device having an LED module and wiring loom electrically coupled with the LED module;

bending the plurality of heat conducting fins to fit into a headlight housing of a vehicle;

inserting the heat dissipation device into the headlight housing so that the LED module is housed within the headlight housing;

securing the heat dissipation device with the headlight housing; and

connecting the wiring loom with the vehicular headlight loom connection.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A heat dissipation device for a light emitting diode (LED) lamp comprising:
a base;
a plurality of heat conducting fins vertically stacked and mechanically coupled with the base, wherein the plurality of heat conducting fins radiate outward from the base; and
an LED module mechanically coupled with the base.

2. The device of claim 1, wherein the base further comprises a thermal conductive grease for maximizing heat transfer between the base on the LED socket.

3. The device of claim 2, wherein the thermal conductive grease is a silicon grease.

4. The device of claim 1, wherein the plurality of heat conducting fins further comprise:
a plurality of vented separators positioned along at least one surface of each of the plurality of heat conducting fins;
a rib feature disposed lengthwise along each surface of each of the plurality of heat conducting fins.

5. The device of claim 4, wherein the plurality of vented separators are vertically aligned between the plurality of heat conducting fins.

6. The device of claim 4, wherein the plurality of vented separators are non-vertically aligned between the plurality of heat conducting fins.

7. The device of claim 1, wherein the plurality of heat conducting fins comprise a semi-rigid heat conductive metal.

8. The device of claim 7, wherein the semi-rigid heat conductive metal is aluminum.

9. A vehicular headlight assembly comprising:
a headlight housing;
a heat dissipation device having an LED lamp wherein the heat dissipation device is removably coupled with the headlight housing, the heat dissipation device comprising:
a base,
a plurality of heat conducting fins vertically stacked and mechanically coupled with the base, wherein the plurality of heat conducting fins radiate outward from the base, and
an LED module mechanically coupled with the base, and
a wiring loom electrically coupled with the LED module for providing connection with a vehicular headlight loom connection.

10. A method for using a heat dissipation device having an LED module comprising:
providing the a heat dissipation device, the heat dissipation device comprising:
a base,
a plurality of heat conducting fins vertically stacked and mechanically coupled with the base, wherein the plurality of heat conducting fins radiate outward from the base, wherein the LED module is mechanically coupled with the base, and
a wiring loom electrically coupled with the LED module for providing connection with a vehicular headlight loom connection;
bending the plurality of heat conducting fins to fit into a headlight housing;
inserting the heat dissipation device into the headlight housing such that the LED module is housed within the headlight housing;
securing the heat dissipation device with the headlight housing; and
connecting the wiring loom with the vehicular headlight loom connection.
